(19) United States
(12) Patent Application Publication
(10) Pub. No.: US 2010/0259825 A1
(43) Pub. Date: Oct. 14, 2010

(54) COMPOSITE BRIGHTNESS ENHANCEMENT FILM HAVING TWO-PHASE HAZING LAYER

(75) Inventors: Jauh-jung Yang, Sinwu (TW); Chi-Feng Chen, Sinwu (TW); Yu-chieh Chen, Sinwu (TW)

Correspondence Address: AUSTIN RAPP & HARDMAN, 170 South Main Street, Suite 735, SALT LAKE CITY, UT, 84101, US

(73) Assignee: DAYU optoelectronics, Taoyuan County (TW)

(21) Appl. No.: 12/561,021

(22) Filed: Sep. 16, 2009

(30) Foreign Application Priority Data
Apr. 14, 2009 (TW) 098112405

(51) Int. Cl. G02B 5/02; G02B 1/10

(52) U.S. Cl. 359/599

(57) ABSTRACT

A composite brightness enhancement film having a two-phase hazing layer is provided, and includes a substrate, a two-phase hazing layer and a brightness enhancement structure layer. The substrate has a light inputting surface and a light outputting surface on which the two-phase hazing layer is formed. The two-phase hazing layer includes at least two resin material uniformly mixed with each other. The at least two resin material is incompletely dissolved into each other, and has different refractive indexes from each other, so that the two-phase hazing layer can be used to diffuse and haze a light. The brightness enhancement structure layer is formed on the two-phase hazing layer, and has a plurality of brightness enhancement micro-structures for enhancing the light.

### CLAIM OF PRIORITY

This application claims priority to Taiwanese Patent Application No. 098112405 filed on Apr. 14, 2009.

### FIELD OF THE INVENTION

The present invention relates to a composite brightness enhancement film having a two-phase hazing layer, and more particularly to a composite brightness enhancement film having a two-phase hazing layer applied to a liquid crystal display (LCD).

### BACKGROUND OF THE INVENTION

Generally, a back light module of a traditional liquid crystal display (LCD) comprises a plurality of optical films, such as light guide plate, diffuser film, diffuser plate, brightness enhancement film and etc., wherein the brightness enhancement film generally includes a substrate and a prism structure layer. The substrate and the prism structure layer are made of transparent resin material, wherein the prism structure layer is formed on the substrate. When a light source of the back light module generates a light, the light passes through the light guide plate and the diffuser film, and enters into the substrate of the brightness enhancement film followed by entering into the prism structure layer of the brightness enhancement film. Thus, when the light emits out of the brightness enhancement film, the light will refract along a suitable angle, so as to provide an optical effect of brightness enhancement. However, when the light emits out of the prism structure layer, negative optical effects, such as Newton's ring and Moire interference, may be occurred, so that the display quality of LCD may be affected. Moreover, referring to FIG. 1A, a traditional brightness enhancement film 50 is illustrated, wherein the brightness enhancement film 50 has a substrate 51 and a brightness enhancement structure layer 52. Referring to FIG. 1B, a traditional composite brightness enhancement film 60 is illustrated, wherein the composite brightness enhancement film 60 has a diffuser plate 61 and a brightness enhancement structure layer 62. In the composite brightness enhancement film 60, because the upper surface of the diffuser plate 61 combines with the brightness enhancement structure layer 62, so that the diffusion effect of the diffuser plate 61 causes the angle distribution of the light entering into the brightness enhancement structure layer 62 apparently greater than the angle distribution of the light entering into the brightness enhancement structure layer 52 of the simple brightness enhancement film 50. Because the incident angle θ₁ of the light 621 (i.e. an included angle between the light 621 emitting to the structure surface of the brightness enhancement structure layer 62 and a normal line 620 thereof) is negative in relation to the normal line 620 and smaller than a critical angle θ_{c} of total internal reflection, too high ratio of the light 621 directly emits out of a prism of the brightness enhancement structure layer 62 and then further laterally emits into an adjacent prism thereof, or scatters outwardly to lose the light 621 after emitting out of the prism. As a result, the brightness enhancement effect of the brightness enhancement structure layer 62 may be lowered or lost.

To solve the foregoing problem, referring now to FIG. 10, WIPO's PCT patent application publication No. 2005/006030 discloses an optical film for a backlight unit and the backlight unit using the same, wherein the optical film 70 comprises a film sheet 71, a refraction pattern 72 and light diffusing particles 73. The film sheet 71 has a surface formed with the refraction pattern 72 for refracting the light to provide a brightness enhancement phenomenon. The light diffusing particles 73 are selected from titanium oxide, zinc oxide, barium sulfate, calcium carbonate, magnesium carbonate, aluminum hydroxide and clay, and the light diffusing particles 73 are distributed in each portion of the refraction pattern 72 and the film sheet 71, so as to provide dual effects of diffusion and brightness enhancement for the light. However, in the process, the light diffusing particles 73 are firstly pre-formed to be particle shape, and then mixed into the base material of the refraction pattern 72 and the film sheet 71. But, when the particle diameter of the light diffusing particles 73 becomes finer, it is uneasy to uniformly disperse the light diffusing particles 73 into liquid base material. Meanwhile, the coagulation problem of the light diffusing particles 73 is serious. As a result, the distribution uniformity of the light diffusing particles 73 and the process yield thereof are low.

Furthermore, US patent application publication No. 2005/0257363 discloses an optical diffusion plate applied for direct-type backlight module and a manufacturing method thereof, wherein the optical diffusion plate comprises a substrate, a saw structure layer and an optical diffusion agent. The substrate has a surface formed with the saw structure layer, while the optical diffusion agent is simultaneously mixed in the substrate and the saw structure layer, so as to provide dual effects of diffusion and brightness enhancement for the light. However, the optical diffusion agent is pre-formed to be particle shape and exposed on the surface of the substrate and the saw structure layer. As a result, the distribution uniformity of the optical diffusion agent and the process yield thereof are low.

In addition, Japanese patent application publication No. 09-304607 discloses a light diffusing film, wherein the light diffusing film comprises a base film and a light diffusing layer. The base film has a surface formed with the light diffusing layer. The light diffusing layer includes a transparent resin and fine particles which are dispersed in the transparent resin, while the surface of the light diffusing layer is a fine rugged face, so as to provide dual effects of diffusion and brightness enhancement for the light. However, the fine particles are pre-formed to be particle shape and exposed on the surface of the light diffusing layer. As a result, the distribution uniformity of the fine particles and the process yield thereof are low.

Besides, Taiwanese utility model patent No. M277950 discloses a light guide plate and a backlight module using the same, wherein the light guide plate comprises a substrate having a lower surface defined as an incident surface for receiving a light and an upper surface defined as an emitting surface opposite to the incident surface. The substrate includes light diffusion particles therein. However, the light diffusion particles are pre-formed to be particle shape and exposed on the incident surface of the substrate. As a result, the distribution uniformity of the light diffusion particles and the process yield thereof are low.

Additionally, other related patents further comprises Taiwanese patent No. I301548, entitled “brightness enhancement film for diffusing and directing light” and Taiwanese patent No. M252937, entitled “light diffuser having a light diffusion layer”, both of which have diffusion particles which are pre-formed to be particle shape, and then mixed into the base material of the prism or the substrate. And, the diffusion particles are exposed on the outer surface of the prism or the substrate. As a result, there are still several technological problems, such as the distribution uniformity of the diffusion particles and the process yield thereof are low. Meanwhile, in fact, all improved structures of the foregoing brightness enhancement films can not apparently improve the technological problem that the light further laterally emits into an adjacent prism or scatters outwardly to lose the light after emitting out of the prism as expectation, i.e. the gain effect for the single-beam transmission efficiency and the light lose factor of all improved structures of the foregoing brightness enhancement films are still too low.

It is necessary to develop a composite brightness enhancement film to solve the problems existing in the traditional technologies, as described above.

### SUMMARY OF THE INVENTION

A primary object of the present invention is to provide a composite brightness enhancement film having a two-phase hazing layer, wherein at least two resin material which is incompletely dissolved into each other and has different refractive indexes from each other are firstly uniformly mixed with each other, and then solidified to form the two-phase hazing layer having variation of refractive indexes and disposed between a substrate and a brightness enhancement structure layer. Thus, negative optical effects, such as Newton's ring and Moire interference, can be efficiently inhibited, while the light diffusion effect, the light hazing effect, the luminance and the uniformity can be enhanced. Furthermore, the single-beam transmission efficiency can be gained, and the light lose factor can be improved.

A secondary object of the present invention is to provide a composite brightness enhancement film having a two-phase hazing layer, wherein at least two resin material is firstly mixed and then solidified to form the two-phase hazing layer. Thus, the traditional problem that the diffusion particles are firstly pre-formed and then mixed to become uneasy to uniformly disperse the diffusion particles in liquid base material can be prevented, so as to efficiently enhance the particle distribution uniformity and the process yield.

To achieve the above object, a composite brightness enhancement film having a two-phase hazing layer of a preferred embodiment of the present invention comprises a substrate, a two-phase hazing layer and a brightness enhancement structure layer. The substrate has a light inputting surface and a light outputting surface on which the two-phase hazing layer is formed. The two-phase hazing layer includes at least two resin material uniformly mixed with each other. The at least two resin material is incompletely dissolved into each other, and has different refractive indexes from each other, so that the two-phase hazing layer can be used to diffuse and haze a light. The brightness enhancement structure layer is formed on the two-phase hazing layer, and has a plurality of brightness enhancement micro-structures for enhancing the light.

In one embodiment of the present invention, the at least two resin material comprises a primary resin material and at least one secondary resin material, and the primary resin material has a refractive index smaller than that of the secondary resin material.

In one embodiment of the present invention, the secondary resin material is irregularly micelles dispersed in the primary resin material.

In one embodiment of the present invention, a portion of the micelles of the secondary resin material contains the primary resin material therein.

In one embodiment of the present invention, the secondary resin material is irregularly waved ripples dispersed in the primary resin material.

In one embodiment of the present invention, the two-phase hazing layer further comprises a plurality of pre-formed diffusion particles dispersed in the primary resin material.

In one embodiment of the present invention, the at least two resin material of the two-phase hazing layer is selected from at least two ultraviolet (UV) curable resins, selected from various UV curable resins including epoxy type resin, urethane type resin, polyethylene (PE) type resin or polyester type resin.

In one embodiment of the present invention, the haze level of the two-phase hazing layer is ranged between 15% and 25%.

In one embodiment of the present invention, the substrate is made of macromolecular polymer resin which can be selected from polyethylene terephthalate (PET), polycarbonate (PC), poly-methyl methacrylate (PMMA), polyethylene (PE), polyvinyl chloride (PVC), polypropylene (PP) or mixture thereof.

In one embodiment of the present invention, the brightness enhancement structure layer is made of ultraviolet (UV) curable resin, selected from various UV curable resins including epoxy type resin, urethane type resin, polyethylene type resin or polyester type resin.

In one embodiment of the present invention, the brightness enhancement micro-structures of the brightness enhancement structure layer are projections of various geometric shapes.

In one embodiment of the present invention, the projections of various geometric shapes are prisms, hemi-circles, cones or pyramids.

In one embodiment of the present invention, the brightness enhancement micro-structures of the brightness enhancement structure layer are projections of various irregular shapes.

In one embodiment of the present invention, the projections of various irregular shapes are prisms, hemi-circles, cones or pyramids having unsymmetrical arrangements, different heights or different widths.

### DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1A is a cross-sectional view of a traditional brightness enhancement film;

FIG. 1B is a cross-sectional view of a traditional composite brightness enhancement film;

FIG. 1C is a cross-sectional view of a traditional optical film for a backlight unit;

FIG. 2 is a perspective view of a composite brightness enhancement film having a two-phase hazing layer according to a preferred embodiment of the present invention;

FIG. 3A is a partially enlarged cross-sectional view of the composite brightness enhancement film having a two-phase hazing layer according to the preferred embodiment of the present invention;

FIG. 3B is another partially enlarged cross-sectional view of the composite brightness enhancement film having a two-phase hazing layer according to the preferred embodiment of the present invention; and

FIG. 4 is an assembled schematic view of the composite brightness enhancement film having a two-phase hazing layer according to the preferred embodiment of the present invention.

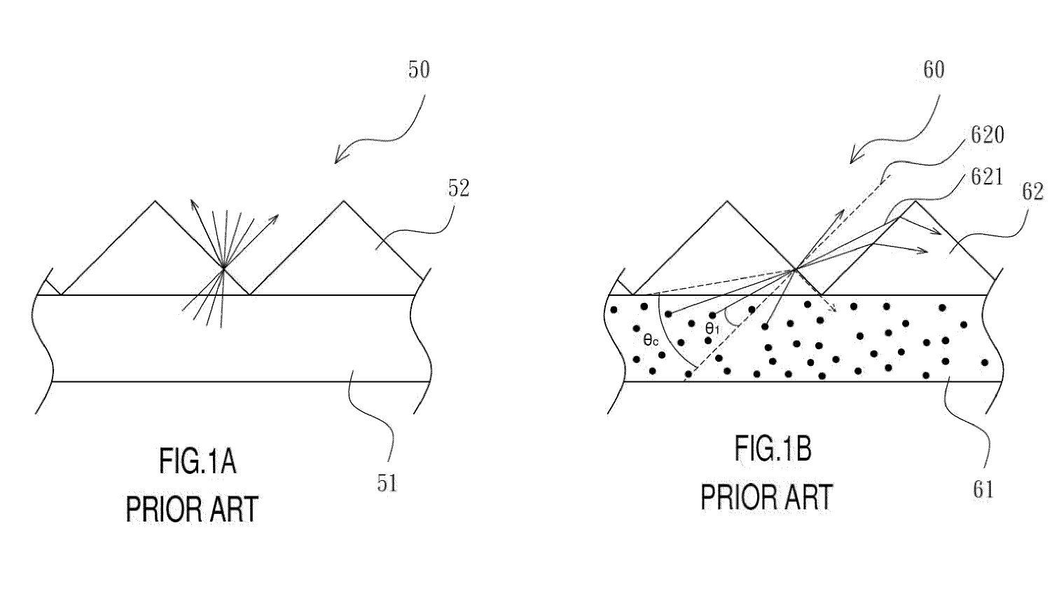

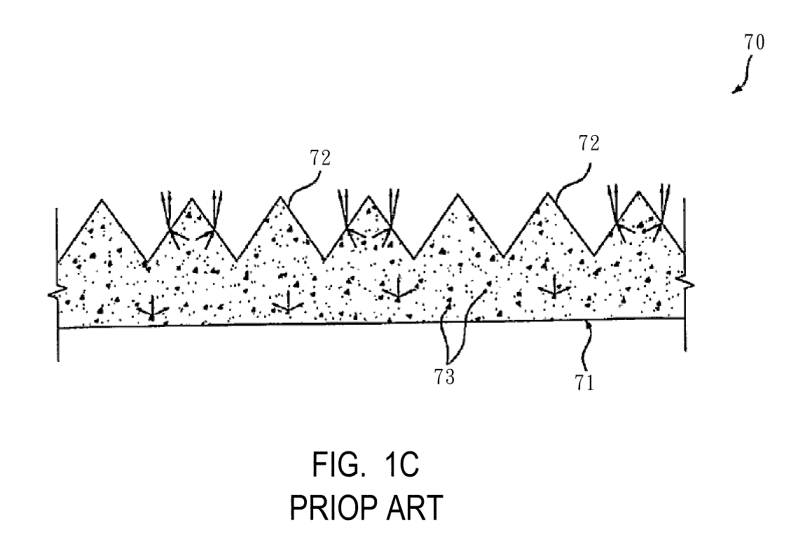

### DETAILED DESCRIPTION OF THE PREFERRED EMBODIMENTS

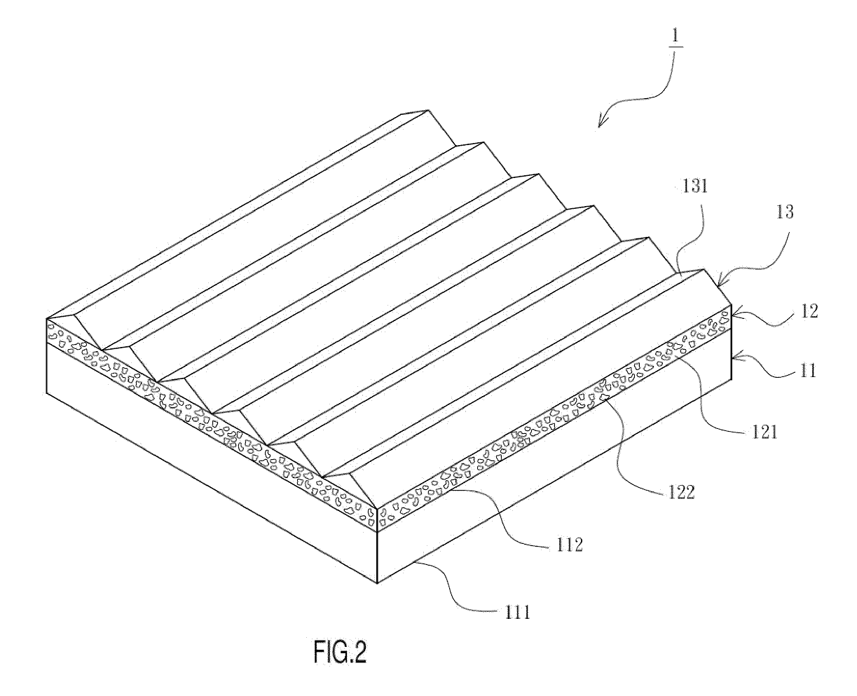

Referring now to FIG. 2, a composite brightness enhancement film having a two-phase hazing layer according to a preferred embodiment of the present invention is illustrated. As shown, the composite brightness enhancement film 1 is preferably applied to a back light module of a liquid crystal display (LCD) for providing dual effects of brightness enhancement and diffusion for the light, efficiently gaining the single-beam transmission efficiency, and improving the light lose factor. However, the composite brightness enhancement film 1 of the present invention may be applied to other types of display devices or other optical technical fields which need to enhance and diffuse the light.

Referring back to FIG. 2, in the preferred embodiment of the present invention, the composite brightness enhancement film 1 having a two-phase hazing layer comprises a substrate 11, a two-phase hazing layer 12 and a brightness enhancement structure layer 13. The substrate 11 is a transparent film made of macromolecular polymer resin, and especially a flexible transparent film, wherein the macromolecular polymer resin can be selected from polyethylene terephthalate (PET), polycarbonate (PC), poly-methyl methacrylate (PMMA), polyethylene (PE), polyvinyl chloride (PVC), polypropylene (PP) or mixture thereof, but not limited thereto. The substrate 11 has a light inputting surface 111 and a light outputting surface 112. The two-phase hazing layer 12 is formed on the light outputting surface 112 of the substrate 11 by suitable coating method, such as select to use a spinning coating method to form the two-phase hazing layer 12 on the light outputting surface 112, but not limited thereto. The coating thickness of the two-phase hazing layer 12 is generally smaller than the single thickness of the substrate 11.

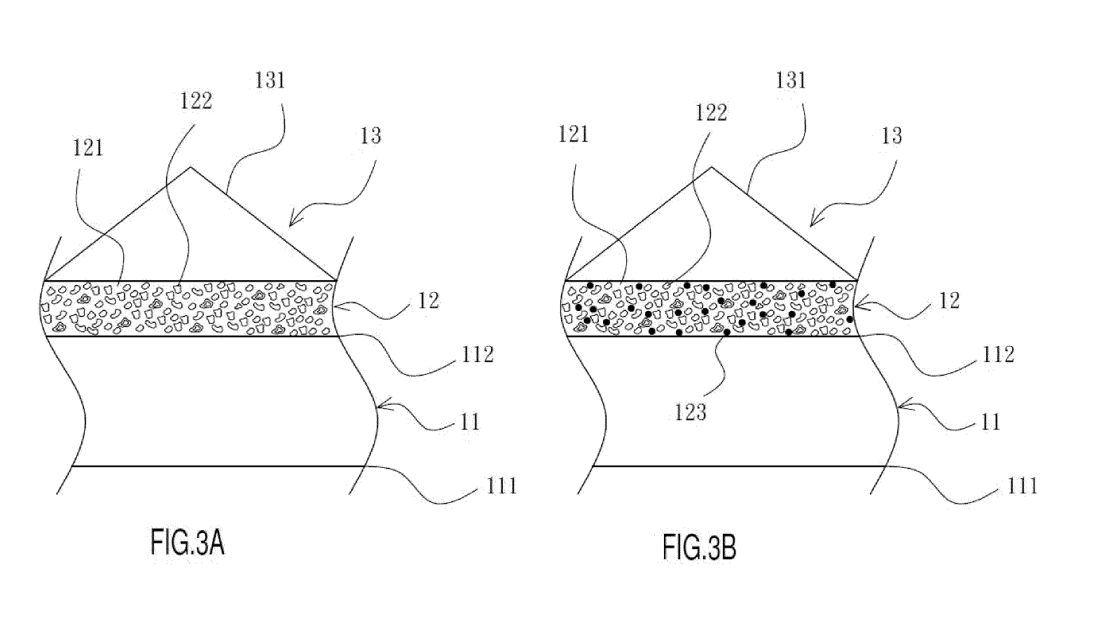

Referring now to FIGS. 2, 3A and 3B, in the preferred embodiment of the present invention, before carrying out the foregoing coating process, the two-phase hazing layer 12 comprises at least two resin material uniformly mixed with each other, wherein the at least two resin material is incompletely dissolved into each other under liquid status and has different refractive indexes from each other due to incomplete identical physical and chemical properties and incomplete identical compositions. The mixing status of incompletely dissolution into each other is similar to the mixing status of stirring oil and water. No matter the oil or the water has higher mixture ratio, the mixture of the oil and the water will generate a plurality of irregular suspended particle after stirring the oil and the water a predetermined time. The present invention uses similar mixing concept to mix the at least two resin material having different refractive indexes from each other. After the at least two resin material incompletely dissolved into each other is mixed and solidified, the light can pass through the two-phase hazing layer 12 to generate the light diffusion effect due to the mixed resin material and different refractive indexes therein, gain the single-beam transmission efficiency, and improve the light lose factor. The mixture dispersion modes of the at least two resin material will be described more detailed by the present invention hereinafter.

In one embodiment of the present invention, the at least two resin material of the two-phase hazing layer 12 is preferably selected from at least two ultraviolet (UV) curable resins, such as selected from various UV curable resins including epoxy type resin, urethane type resin, polyethylene (PE) type resin or polyester type resin, but not limited thereto, the at least two resin material may be selected from other type of UV curable resins. In the embodiment, the at least two resin material comprises a primary resin material 121 and at least one secondary resin material 122, and the primary resin material 121 has a refractive index smaller than that of the secondary resin material 122. It should be noted that the type of the secondary resin material 122 can be a single type, two types, or more than two types. In the present invention, the difference of refractive indexes between resin material can be adjusted by selecting suitable type resins, so as to control and set the light diffusion level (i.e. the haze level) of the two-phase hazing layer 12. Furthermore, the coating thickness, the mixture dispersion modes and other factors of the two-phase hazing layer 12 may affect the light diffusion level. Thus, during the coating process, the resin type, the difference of refractive indexes, the coating thickness and/or the mixture dispersion modes can be adjusted according to product needs, in order to obtain a desired light diffusion level. The mixture dispersion modes can be adjusted by changing various factors including the mixture ratio, the stirring speed, the stirring time and/or the spinning coating speed under liquid status.

For example, in FIG. 3A, the secondary resin material 122 is various irregularly micelles dispersed in the primary resin material 121, or various irregularly waved ripples (not-shown) dispersed in the primary resin material 121. The particle diameter of the micelles (or the curvature and width of the waved ripples) and the irregular level thereof will affect the light diffusion effect. Thus, the foregoing factors can be adjusted by changing the mixture ratio, the stirring speed, the stirring time and/or the spinning coating speed under liquid status. In addition, a portion of the micelles of the secondary resin material 122 contains a trace portion of the primary resin material 121 therein, so that the light passing through the micelles will generate multiple light diffusion effects for gaining the single-beam transmission efficiency and improving the light lose factor. Besides, the two-phase hazing layer 12 may be mixed with a trace portion of a plurality of irregular air bubbles (not-shown) during stirring, wherein the irregular air bubbles are dispersed in the primary resin material 121. Because the air contained in the irregular air bubbles has a refractive index different from that of the primary resin material 121, so that the irregular air bubbles can generate an auxiliary light diffusion effect. On the other hand, in FIG. 3B, the two-phase hazing layer 12 can further comprise a plurality of pre-formed diffusion particles 123 which are firstly pre-formed to be particle shape, and then mixed/dispersed in the primary resin material 121. The pre-formed diffusion particles 123 have a refractive index different from that of the primary resin material 121, so as to increase an auxiliary light diffusion effect. However, the amount of the pre-formed diffusion particles 123 is preferably controlled to be lower than that of the secondary resin material 122. The pre-formed diffusion particles 123 can be selected from various traditional diffusion particles, such as particles made of titanium oxide, zinc oxide, barium oxide, barium sulfate, calcium carbonate, magnesium carbonate, aluminum hydroxide and/or clay, but not limited thereto.

Referring still to FIGS. 3A and 3B, in the preferred embodiment of the present invention, the particle diameter of the micelles (or the curvature and width of the waved ripples) can be adjusted according to product needs, without limitation. In the present invention, the primary resin material 121 and the secondary resin material 122 is firstly mixed with each other under liquid status, and then a suitable mixture dispersion mode will be formed by stirring and spinning coating. Therefore, although the primary resin material 121 and the secondary resin material 122 is incompletely dissolved into each other and has different refractive indexes from each other, the secondary resin material 122 is substantially uniformly dispersed in the entire structure of the primary resin material 121, so as to construct the two-phase hazing layer 12 having variation of refractive indexes. In the present invention, the haze level provided by the two-phase hazing layer 12 can be controlled to be ranged between 15% and 25% according to product needs, and preferably 20%, for efficiently inhibiting negative optical effects, such as Newton's ring and Moire interference.

Referring to FIGS. 2, 3A and 3B again, in the preferred embodiment of the present invention, the brightness enhancement structure layer 13 is formed on the two-phase hazing layer 12 by suitably traditional coating methods, such as rolling coating, dry-film pressing coating or negative-mold coating, but not limited thereto. In the embodiment, the brightness enhancement structure layer 13 is preferably made of ultraviolet (UV) curable resin, such as selected from various UV curable resins including epoxy type resin, urethane type resin, polyethylene (PE) type resin or polyester type resin. In the present invention, the brightness enhancement structure layer 13 has a plurality of convex brightness enhancement micro-structures 131, but not limited to the shape thereof. The shape of the brightness enhancement micro-structures 131 are preferably projections of various geometric shapes, such as prisms as shown in FIG. 2, but not limited thereto. Other projections of geometric shapes include convex hemi-circles, cones, triangular pyramids, tetragonal pyramids (not-shown) and etc. Alternatively, the brightness enhancement micro-structures 131 of the brightness enhancement structure layer 13 can be projections of various irregular shapes, such as prisms, hemi-circles, cones, triangular pyramids or tetragonal pyramids having unsymmetrical arrangements, different heights or different widths.

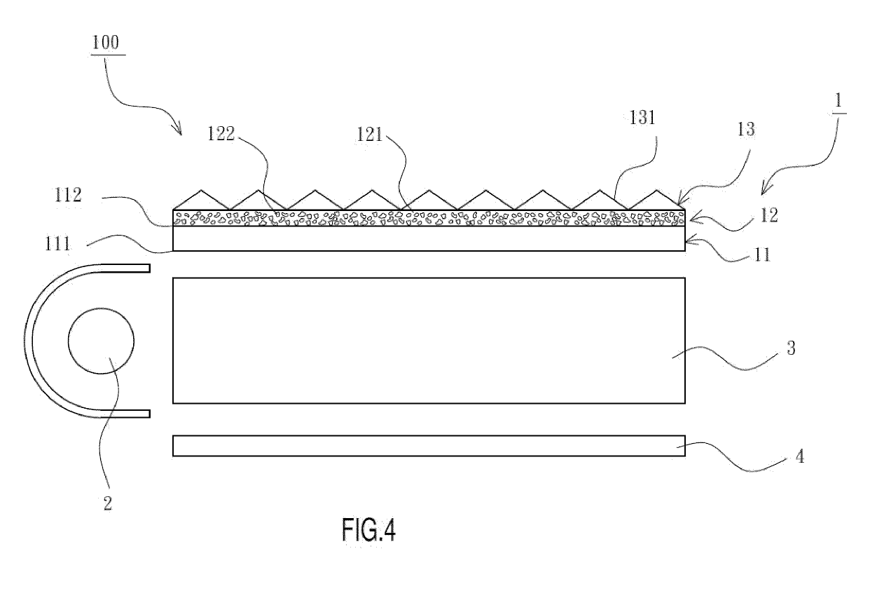

Referring now to FIGS. 3A, 3B and 4, in the preferred embodiment of the present invention, the composite brightness enhancement film 1 can be applied to a back light module 100 which comprises at least one composite brightness enhancement film 1, at least one light source 2, a light guide plate 3 and a reflective plate 4. The at least one light source 2 is selectively located adjacent to (or under) the light guide plate 3, and the at least one light source 2 can generate light, such as white light. The light guide plate 3 is used to provide the light refraction effect for guide the light to emit into the composite brightness enhancement film 1 after several refractions. The reflective plate 4 is disposed under the light guide plate 3 for refracting the light emitted out of the light guide plate 3 to return into the light guide plate 3, in order to increase the light utility ratio. The at least one composite brightness enhancement film 1 of the present invention is disposed over the light guide plate 3, wherein the irregularly micelles of the secondary resin material 122 randomly dispersed in the primary resin material 121 of the two-phase hazing layer 12 can provide the light diffusion effect and the haze effect (the haze level is ranged between 15% and 25%) for efficiently inhibiting negative optical effects, such as Newton's ring and Moire interference, while the brightness enhancement structure layer 13 can provide the brightness enhancement effect for the light. Especially, it can efficiently prevent the light diffused by the two-phase hazing layer 12 from emitting out of the brightness enhancement structure layer 13 along a negative incident angle which is smaller than a critical angle θ_{c} of total internal reflection of the brightness enhancement structure layer 13. Thus, it can avoid the light emitted out of the brightness enhancement structure layer 13 from further laterally emitting into an adjacent portion thereof, or from scattering outwardly to lose the light. As a result, in the present invention, the single-beam transmission efficiency can be efficiently gained, and the light lose factor can be efficiently improved. Because the composite brightness enhancement film 1 of the present invention can provide dual effects of light diffusion and light hazing. Therefore, it is unnecessary to install other diffusion plate (not-shown) between the composite brightness enhancement film 1 and the light guide plate 3, so as to relatively simplify the installation structure and the installation procedure of the back light module 100.

As described above, various traditional composite brightness enhancement films which have diffusion particles mixed in the substrate and/or the prism structure layer. However, the diffusion particles are pre-formed to be particle shape, and there are still several technological problems of the exposed diffusion particles, such as the distribution uniformity of the diffusion particles and the process yield thereof are low. As a result, in fact, the gain effect for the single-beam transmission efficiency and the light lose factor are still too low. In comparison with the traditional composite brightness enhancement films, at least two resin material of the present invention, as shown in FIGS. 2 to 4, which is incompletely dissolved into each other and has different refractive indexes from each other are firstly uniformly mixed with each other, and then solidified to form the two-phase hazing layer 12 having variation of refractive indexes and disposed between the substrate 11 and the brightness enhancement structure layer 13. Thus, negative optical effects, such as Newton's ring and Moire interference, can be efficiently inhibited, while the light diffusion effect, the light hazing effect, the luminance and the uniformity can be enhanced. Furthermore, the single-beam transmission efficiency can be gained, and the light lose factor can be improved. In addition, because at least two resin material of the present invention is firstly mixed and then solidified to form the two-phase hazing layer 12, the traditional problem that the diffusion particles are firstly pre-formed and then mixed to become uneasy to uniformly disperse the diffusion particles in liquid base material can be prevented, so as to efficiently enhance the particle distribution uniformity and the process yield.

The present invention has been described with a preferred embodiment thereof and it is understood that many changes and modifications to the described embodiment can be carried out without departing from the scope and the spirit of the invention that is intended to be limited only by the appended claims.

1. A composite brightness enhancement film having a two-phase hazing layer, comprising:
a substrate having a light inputting surface and a light outputting surface;
a two-phase hazing layer formed on the light outputting surface of the substrate, the two-phase hazing layer including at least two resin material uniformly mixed with each other, wherein the at least two resin material is incompletely dissolved into each other and has different refractive indexes from each other; and
a brightness enhancement structure layer formed on the two-phase hazing layer, and having a plurality of brightness enhancement micro-structures.

2. The composite brightness enhancement film having the two-phase hazing layer according to claim 1, wherein the at least two resin material comprises a primary resin material and at least one secondary resin material, and the primary resin material has a refractive index smaller than that of the secondary resin material.

3. The composite brightness enhancement film having the two-phase hazing layer according to claim 2, wherein the secondary resin material is irregularly micelles or irregularly waved ripples, which are dispersed in the primary resin material.

4. The composite brightness enhancement film having the two-phase hazing layer according to claim 3, wherein a portion of the micelles of the secondary resin material contains the primary resin material therein.

5. The composite brightness enhancement film having the two-phase hazing layer according to claim 2, wherein the two-phase hazing layer further comprises a plurality of pre-formed diffusion particles dispersed in the primary resin material.

6. The composite brightness enhancement film having the two-phase hazing layer according to claim 1, wherein the at least two resin material of the two-phase hazing layer is selected from at least two UV curable resins.

7. The composite brightness enhancement film having the two-phase hazing layer according to claim 6, wherein the UV curable resins are selected from UV curable resins of epoxy type resin, urethane type resin, polyethylene type resin or polyester type resin.

8. The composite brightness enhancement film having the two-phase hazing layer according to claim 1, wherein the haze level of the two-phase hazing layer is ranged between 15% and 25%.

9. The composite brightness enhancement film having the two-phase hazing layer according to claim 1, wherein the substrate is made of macromolecular polymer resin.

10. The composite brightness enhancement film having the two-phase hazing layer according to claim 9, wherein the macromolecular polymer resin is selected from polyethylene terephthalate, polycarbonate, poly-methyl methacrylate, polyethylene, polyvinyl chloride, polypropylene or mixture thereof.

11. The composite brightness enhancement film having the two-phase hazing layer according to claim 1, wherein the brightness enhancement structure layer is made of UV curable resin.

12. The composite brightness enhancement film having the two-phase hazing layer according to claim 11, wherein the UV curable resin is selected from UV curable resins of epoxy type resin, urethane type resin, polyethylene type resin or polyester type resin.

13. The composite brightness enhancement film having the two-phase hazing layer according to claim 1, wherein the brightness enhancement micro-structures of the brightness enhancement structure layer are projections of geometric shapes.

14. The composite brightness enhancement film having the two-phase hazing layer according to claim 13, wherein the projections of geometric shapes are prisms, hemi-circles, cones or pyramids.

15. The composite brightness enhancement film having the two-phase hazing layer according to claim 1, wherein the brightness enhancement micro-structures of the brightness enhancement structure layer are projections of irregular shapes.

16. The composite brightness enhancement film having the two-phase hazing layer according to claim 15, wherein the projections of various irregular shapes are prisms, hemi-circles, cones or pyramids having unsymmetrical arrangements, different heights or different widths.
